(19) United States
(12) Patent Application Publication
(10) Pub. No.: US 2013/0175262 A1
(43) Pub. Date: Jul. 11, 2013

(54) MICROWAVE OVEN WITH ANTENNA ARRAY

(71) Applicants: Ranjit Gharpurey, Austin, TX (US); Jacob A. Abraham, Austin, TX (US)

(72) Inventors: Ranjit Gharpurey, Austin, TX (US); Jacob A. Abraham, Austin, TX (US)

(21) Appl. No.: 13/734,398

(22) Filed: Jan. 4, 2013

Related U.S. Application Data
(60) Provisional application No. 61/583,912, filed on Jan. 6, 2012.

(51) Int. Cl. H05B 6/72

(52) U.S. Cl. CPC H05B 6/72
USPC 219/745

(57) ABSTRACT

Techniques are disclosed relating to microwave ovens. In one embodiment, an apparatus is disclosed that includes a microwave heating unit. The microwave heating unit is configured to radiate microwaves into a cavity and includes an antenna array coupled to one or more amplifiers. The antenna array is configured to generate the radiated microwaves. In some embodiments, the microwave oven is configured to measure temperatures of a item within the cavity, and to steer a microwave beam produced by the antenna array based on the measured temperatures.

The present application claims priority to U.S. Provisional Appl. No. 61/583,912, filed Jan. 6, 2012; the disclosure of which is incorporated by reference herein in its entirety.

### BACKGROUND

1. Technical Field

This disclosure relates generally to appliances, and, more specifically, to microwave ovens.

2. Description of the Related Art

Microwave ovens cook food by radiating microwaves through a cavity to perform dielectric heating. Microwave ovens have traditionally generated microwaves with a magnetron, which converts high-voltage energy to microwave radiation. Magnetrons can be rather large and consume large amounts of power. Magnetrons also tend to have a wide frequency variance, rather than consistently generating microwaves at a specific frequency such as 2.45 GHz, which is a suitable for microwave ovens.

### SUMMARY

The present disclosure describes embodiments of structures and techniques that may be used by a microwave oven.

In one embodiment, a microwave oven may include one or more antenna arrays configured to radiate microwaves into a cavity of the microwave. The microwave oven may power the antenna arrays with one or more solid-state amplifiers that amplify an RF input signal provided to antennas in the antenna arrays. High efficiency amplifiers such as switching amplifiers may be employed for the application. In one embodiment, the microwave oven is configured to focus the microwaves produced by an antenna array into one or more microwave beams directed at an item in the cavity.

In some embodiments, the microwave oven may include one or more thermal sensors to identify warmer locations and colder locations of items. The microwave oven may then steer the microwave beams to target particular locations (e.g., cold spots on the item). In some embodiments, the microwave oven may produce different frequency ranges of microwaves to target heating different depths in items. The microwave oven may be configured to adjust these frequency ranges to change the depths at which an item is heated.

In some instances, the microwave oven described herein may be more effective at heating items while also consuming less power than prior microwave ovens.

In some embodiments it may be possible to reduce the weight and dimensions of the oven

In some embodiments it may be possible to design the oven with non-cuboidal form factors, such as cylindrical shapes.

### BRIEF DESCRIPTION OF THE DRAWINGS

FIGS. 1A and 1B are block diagrams illustrating embodiments of a microwave oven.

FIG. 2 is a block diagram illustrating one embodiment of an antenna array within the microwave oven.

FIG. 3 is a block diagram illustrating one embodiment of a controller unit within the microwave oven.

FIG. 4 is a block diagram illustrating an example of using beam steering to target different heating areas.

FIG. 5 is a block diagram illustrating an example of using different frequencies to target different heating depths.

FIG. 6 is a flow diagram illustrating one embodiment of a method performed by the microwave oven.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

### DETAILED DESCRIPTION

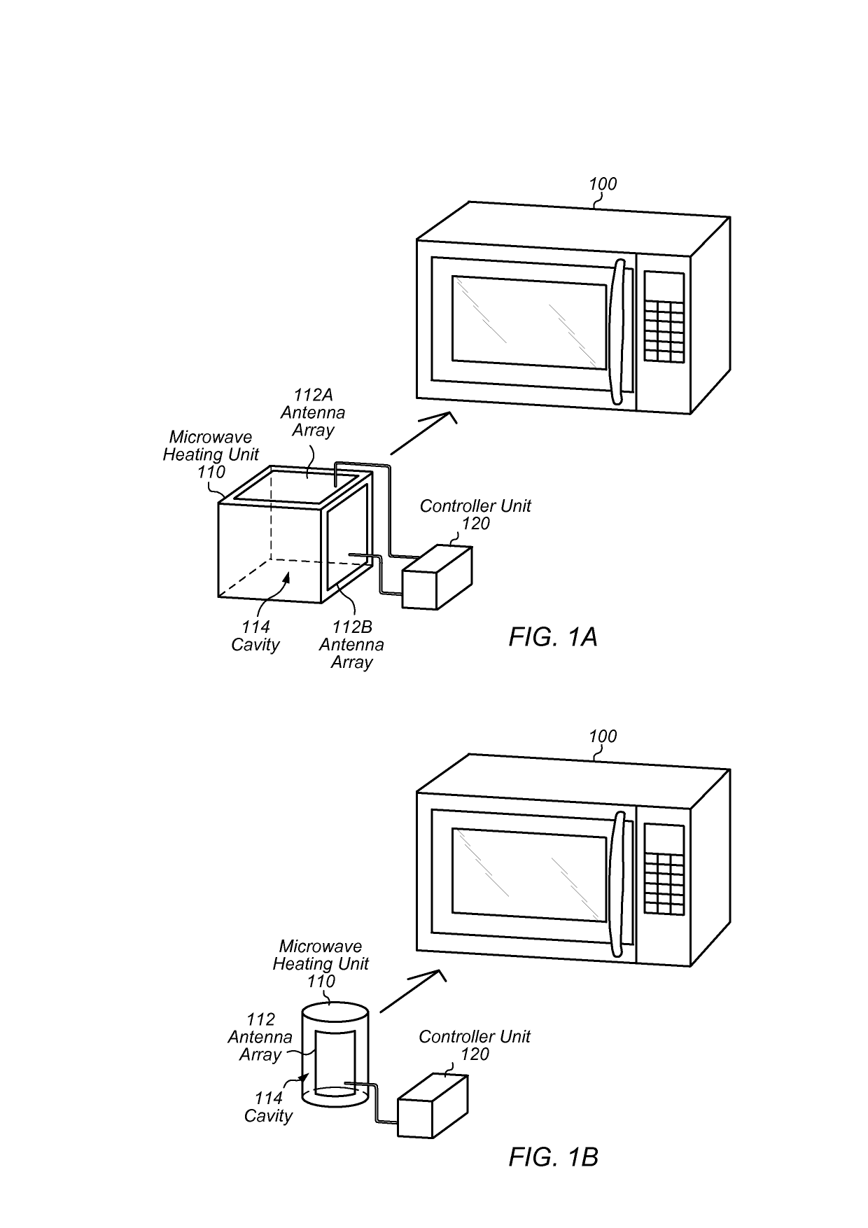

Turning now to FIG. 1A, a block diagram of a microwave oven 100 is depicted. As will be described below, microwave oven 100 is one embodiment of a microwave oven that is configured to heat items using an antenna array. In the illustrated embodiment, microwave oven 100 includes a microwave heating unit 110 and a controller unit 120.

Microwave heating unit 110, in one embodiment, is configured to radiate microwaves into a cavity 114 by using one or more antenna arrays 112. In the illustrated embodiment, microwave heating unit 110 has a cuboidal structure (i.e., a “rectangular-box” structure) that defines a cuboidal cavity 114 for storing items being heated. Heating unit 110 includes a first antenna array 112A positioned along a first surface of cavity 114 and a second antenna array 112B positioned along a second surface of cavity 114. In some embodiments, heating unit 110 may include more or less antenna arrays 112 than shown; in some embodiments, multiple arrays 112 may be included along a single surface. In various embodiments, heating unit 110 may have a different structure than shown such as described below with respect to FIG. 1B.

Controller unit 120, in one embodiment, is configured to coordinate operation of antenna arrays 112. As will be discussed with subsequent Figs., in various embodiments, controller unit 120 may be configured to generate one or more radio-frequency (RF) input signals for antennas arrays 112. As used herein, the term “RF” refers to signals having a frequency between 3 kHz to 300 GHz. Accordingly, in one embodiment, controller unit 120 may generate an RF signal having a frequency of 2.45 GHz (which, as noted above, is a suitable frequency for microwave ovens). In some embodiments, the generated RF signals may then be amplified and phase shifted before being provided to antennas in antenna arrays 112. Antenna arrays 112 may then radiate microwaves at the frequencies of the generated RF signals.

In one embodiment, controller unit 120 is further configured to focus microwaves produced by antenna arrays 112 into one or more microwave beams to facilitate heating items. To the focus the microwaves, controller unit 120, in various embodiments, adjusts the phase and/or amplitude of a generated RF signal for each antenna in an array 112. As will be discussed below, in some embodiments, controller unit 120 is configured to steer (i.e., control the direction of) the beams based on thermal information collected by one or more thermal sensors. For example, in one embodiment, controller unit 120 may be configured to identify colder locations on an item being heated, and to direct one or more beams to those locations to achieve a more-even heating distribution.

In one embodiment, controller unit 120 is further configured to vary the frequency of a generated RF signal to change the depth at which dielectric heating occurs within an item (as the penetration depth of a microwave varies inversely to the frequency of the wave). For example, in one embodiment, controller unit 120 may cycle the frequency of microwaves through a range of different frequencies during the heating cycle. In some embodiments, controller unit 120 may be further configured to select particular frequencies based on properties of the item being heating such as an item's size, weight, current temperature, etc. In various embodiments, controller unit 120 may also simultaneously produce different frequency ranges of microwaves to cause dielectric heat at multiple depths.

Turning now to FIG. 1B, another embodiment of microwave oven 100 is shown. As noted above, heating unit 110 may have any suitable structure. Accordingly, in the illustrated embodiment, microwave oven 100 includes a microwave heating unit 110 that has a cylindrical structure defining a cylindrical cavity 114. As shown, an antenna array 112 is curved around the cylindrical surface of cavity 114. In some embodiments, additional antenna arrays 112 may be included along the upper and/or lower circular surfaces of unit 110. In some embodiments, using a heating unit 110 with an irregular shape (i.e., a non-rectangular-box shape) may allow microwave oven 100, in turn, to a non-traditional microwave-oven shape.

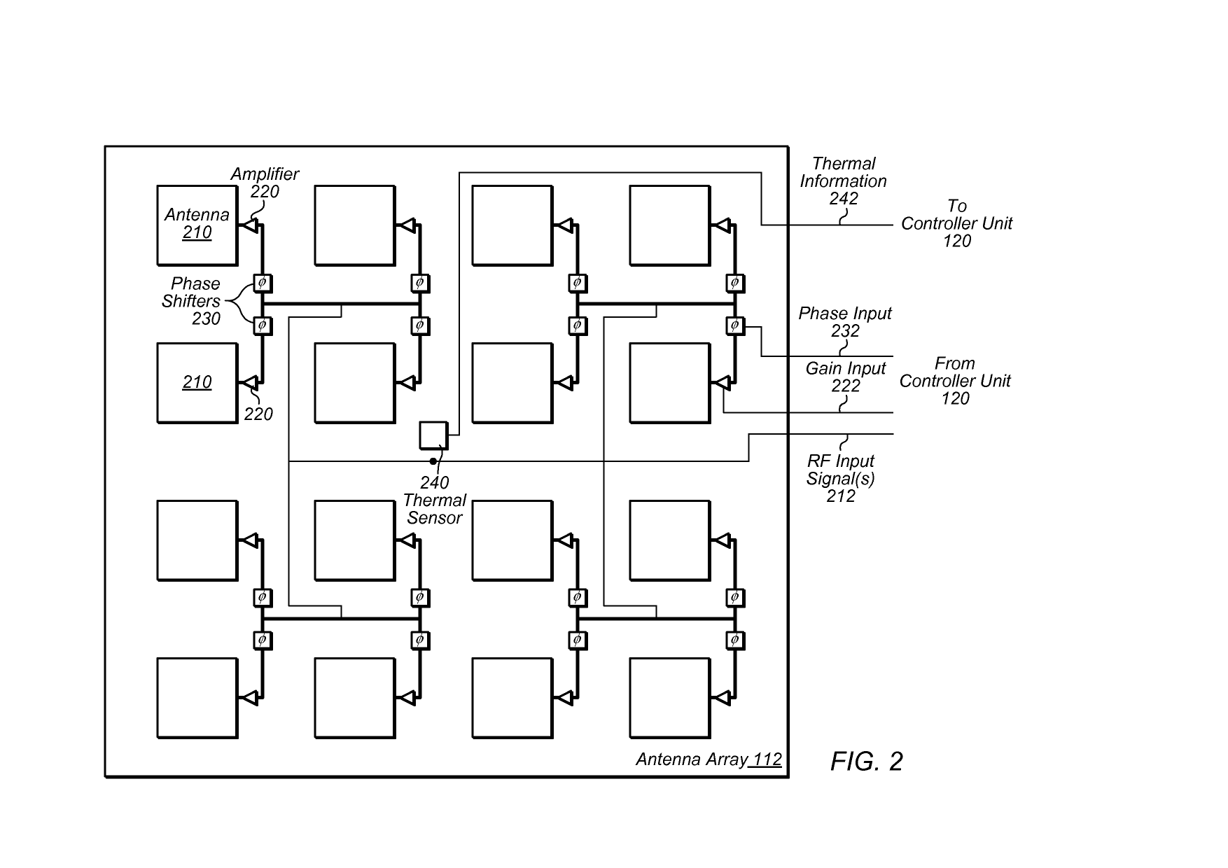

Antenna arrays 112 and controller unit 120 will now be discussed in further detail with respect to FIGS. 2-5.

Turning now to FIG. 2, a block diagram of an antenna array 112 is depicted. In the illustrated embodiment, antenna array 112 includes a plurality of antennas 210, which are each coupled to a respective amplifier 220. Each amplifier 220, in turn, is coupled to a respective phase shifter 230. Antenna array 112 also includes a thermal sensor 240. It is noted that, although units 220, 230, and 240 are shown as being apart of antenna array 112 for illustration purposes, units 220-240 may be considered as being independent of array 112, in some embodiments. For example, in one embodiment, amplifiers 220 and phase shifters 230 may be located within controller unit 120, and thermal sensor 240 may positioned in a different location within heating unit 110 than antenna array 112. In some embodiments, antenna array 112 may include more or less of units 210-240.

Antennas 210, in one embodiment, are configured to radiate microwave energy into cavity 114. Antennas 210 may be any suitable type of antenna. In one embodiment, antennas 210 are isotropic (i.e., omni-directional) antennas. In alternative embodiments directional antennas may be employed. In the illustrated embodiment, antennas 210 radiate microwave energy in response to an RF input signal 212 that is phase shifted by shifters 230 and amplified by amplifiers 220 prior to being provided to antennas 210. As noted above, in some embodiments, controller unit 120 may provide RF signals 212 within different frequency ranges to antenna array 112. For example, a first portion of antennas 210 may receive a first RF input signal 212 within a first range (e.g., within +/−30 MHz of 2.45 GHZ) to cause them to produce microwaves within the first range, and a second portion of antennas 210 may receive a second RF input signal 212 within a second range (e.g., within +/−30 MHz of 5.8 GHZ) to cause them to produce microwaves within the second range.

Amplifiers 220, in one embodiment, are configured to amplify a signal 212 for a respective antenna 210. Amplifiers 220 may be any suitable type of amplifier. In one embodiment, amplifiers 220 are solid-state amplifiers, which may use MOSFET-type devices (as opposed to amplifiers that are vacuum-tube based). In some embodiments, amplifiers 220 are also power amplifiers, which can be switching amplifiers in design, such as class-D amplifiers or class-E amplifiers. In one embodiment, amplifiers 220 may have a power output rating of 1.75-2.25 W. In the illustrated embodiment, each amplifier 220 is configured to adjust its respective gain based on a respective gain input 222 received from controller unit 120. In some embodiments, controller unit 120 is configured to adjust the gains of amplifiers 220 to facilitate microwave beam creation and beam steering.

Through the use of beam steering the requirement for mechanical stirring of microwave energy is obviated.

Phase shifters 230, in one embodiment, are configured to adjust the phase of a signal 212 for a respective antenna 210. In the illustrated embodiment, controller unit 120 selects the phase adjustment of each shifter 230 by providing a phase input 232. In some embodiments, these phase adjustments are used along gain adjustments to facilitate microwave beam creation and beam steering.

Thermal sensor 240, in one embodiment, is configured to determine thermal information 242 used to control the steering of microwave beams. Thermal sensor 240 may be any suitable type of sensor configured to determine temperatures of items. In one embodiment, thermal sensor 240 is one of multiple infrared diodes placed in various locations within heating unit 110. In another embodiment, thermal sensor 240 is a thermal imaging sensor that is configured to capture several temperatures simultaneously within a thermal image (a bitmap of temperature values).

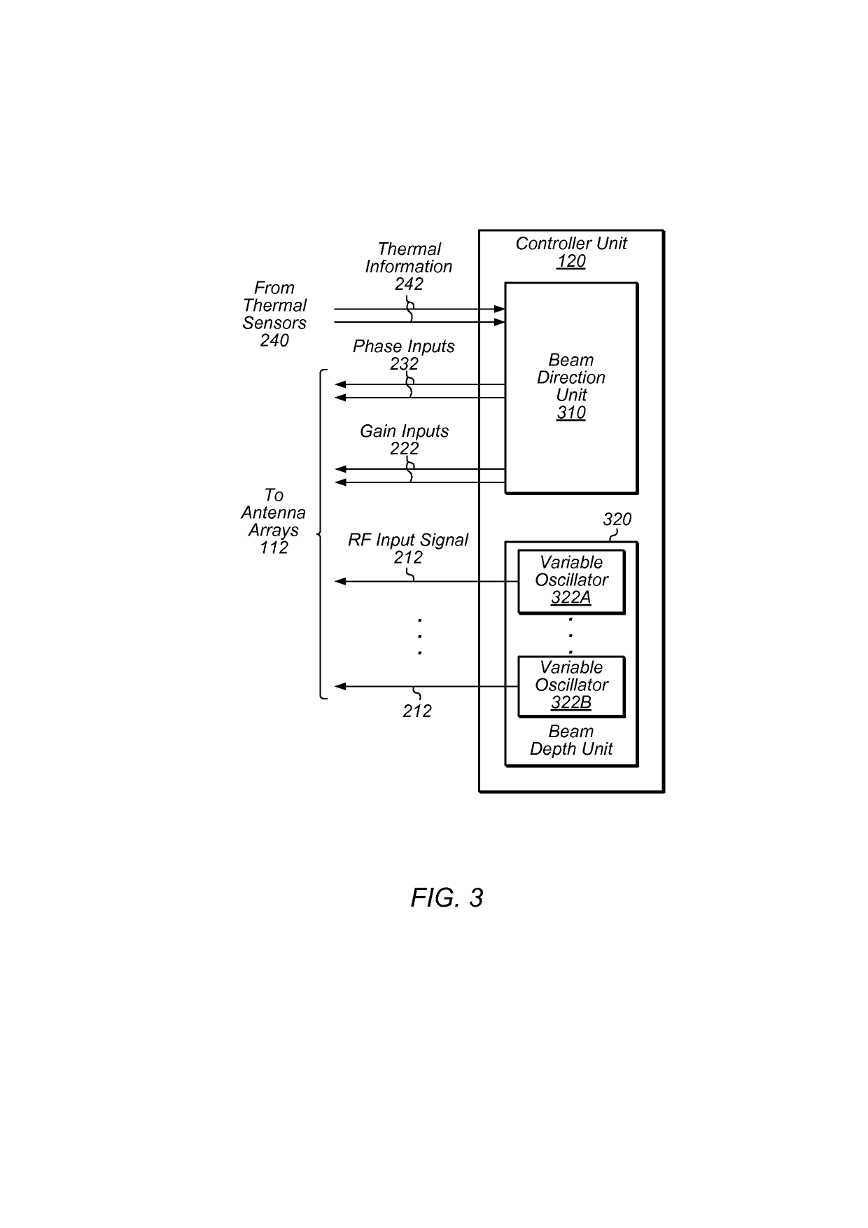

Turning now to FIG. 3, a block diagram of controller unit 120 is depicted. In the illustrated embodiment, controller unit 120 includes a beam direction unit 310 and a beam depth unit 320.

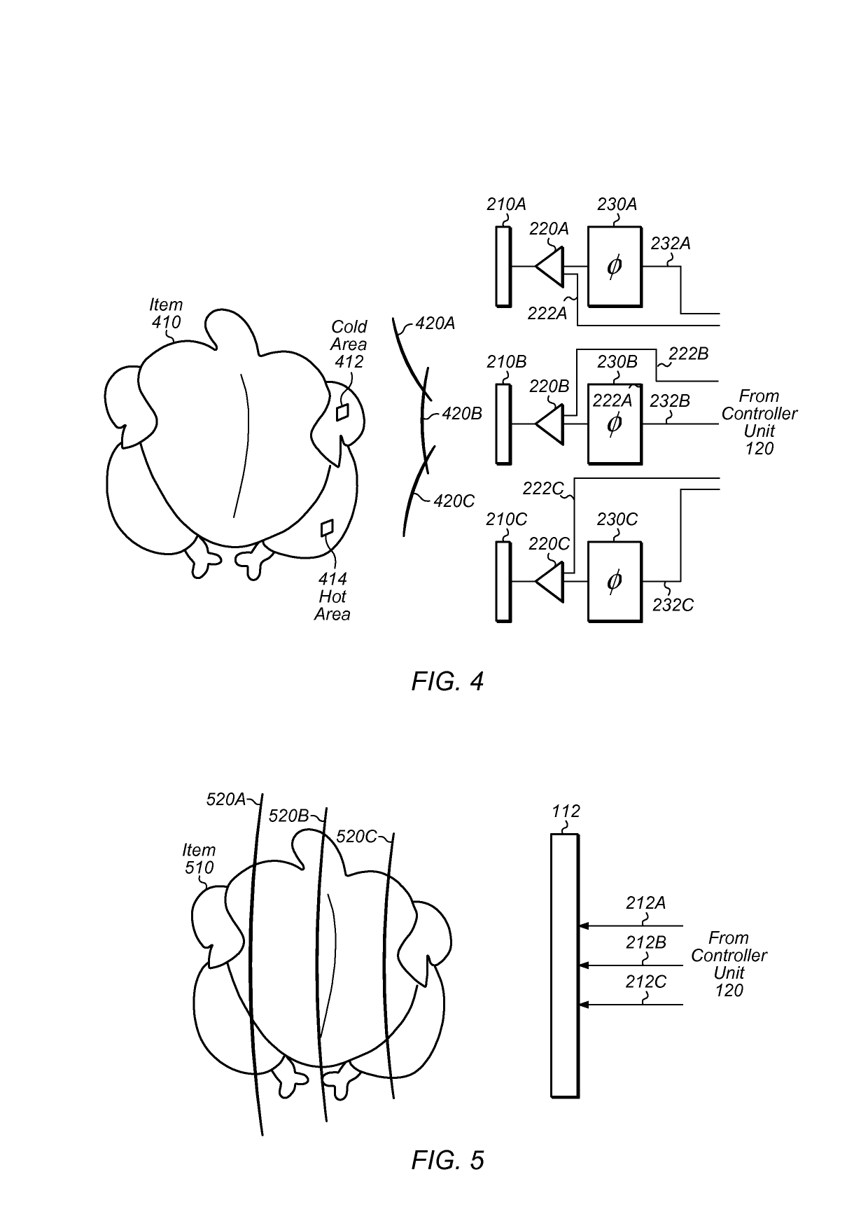

Beam direction unit 310, in one embodiment, is configured to control the focusing of microwaves into one or more beams, and to control the steering of the beams. In the illustrated embodiment, beam direction unit 310 receives thermal information 242 from one or more thermal sensors 240. In various embodiments, beam direction unit 310 uses this information 242 to identify hotter locations and colder locations on an item being heated. Beam direction unit 310 may then adjust the phase inputs 232 of shifters 230 and gain inputs 222 of amplifiers 220 to redirect the beams to different locations to achieve better heating distribution. An example illustrating beam steering is discussed below in conjunction with FIG. 4.

Beam depth unit 320, in one embodiment, is configured to control the depth or depths at which dielectric heating occurs in an item. In the illustrated embodiment, beam depth unit 320 includes multiple variable oscillators 322A-B, each configured to generate a respective RF input signal 212 have a different respective frequency. In some embodiments, beam depth unit 320 may be configured to adjust the frequencies produced by oscillators 322 based one or more criteria. Accordingly, in one embodiment, frequencies may be selected based on the current stage of a cooking cycle—e.g., lower frequencies earlier in the cycle and higher frequencies later. In one embodiment, frequencies may be selected based on the temperature of an item (as determined by sensors 240, user input, etc.)—e.g., lower frequencies for frozen items and higher frequencies as items thaw. In one embodiment, frequencies may be selected based on the size or weight (as determined by a scale in oven 100, user input, etc.)—e.g., lower frequencies for larger items and higher frequencies for smaller items. In one embodiment, frequencies may be selected based on the type of item (e.g., popcorn versus bacon). An example illustrating the generation of different microwave frequencies to target different heating depths is discussed below in conjunction with FIG. 5.

Turning now to FIG. 4, a block diagram illustrating an example of beam steering is depicted. In this example, an item 410 is being heated using microwaves 420 from antennas 210A-C. (Although item 410 is depicted as a chicken for illustrative purposes, item 410 may be any suitable item; item 410 may also be something other than food.) Item 410 has a cold area 412 and hot area 414, which may be identified by a thermal sensor 240. To more evenly heat item 410, controller unit 120 has steered the beam created by the constructive interference of microwaves 420 to be focused on cold area 412. Controller unit 120 may change the focus of the beam by selecting an earlier phase for antennas 210A and 210C (via inputs 232A and 232C to shifters 230A and 230C) and a later phase for antenna 210B (via input 232B to shifter 230B) since antennas 210A and 210C further away from cold area 412 than antenna 210B. Controller unit 120 may also adjust the amplitudes of waves 410 via inputs 222A-C to amplifiers 220A-C based on the distance of antennas 210 to area 412.

Turning now to FIG. 5, a block diagram illustrating an example of using different frequencies to target different heating depths is depicted. In this example, an item 510 is being heated using different frequencies of microwaves 520A-C. Microwaves 520A have the lowest frequency causing them to penetrate the furthest into item 510, while microwaves 520C have the highest frequency causing them to penetrate the least into 510. Controller unit 120 provides different-frequency input signals 212A-C to cause antenna array 112 to produce the different frequencies of microwaves 520.

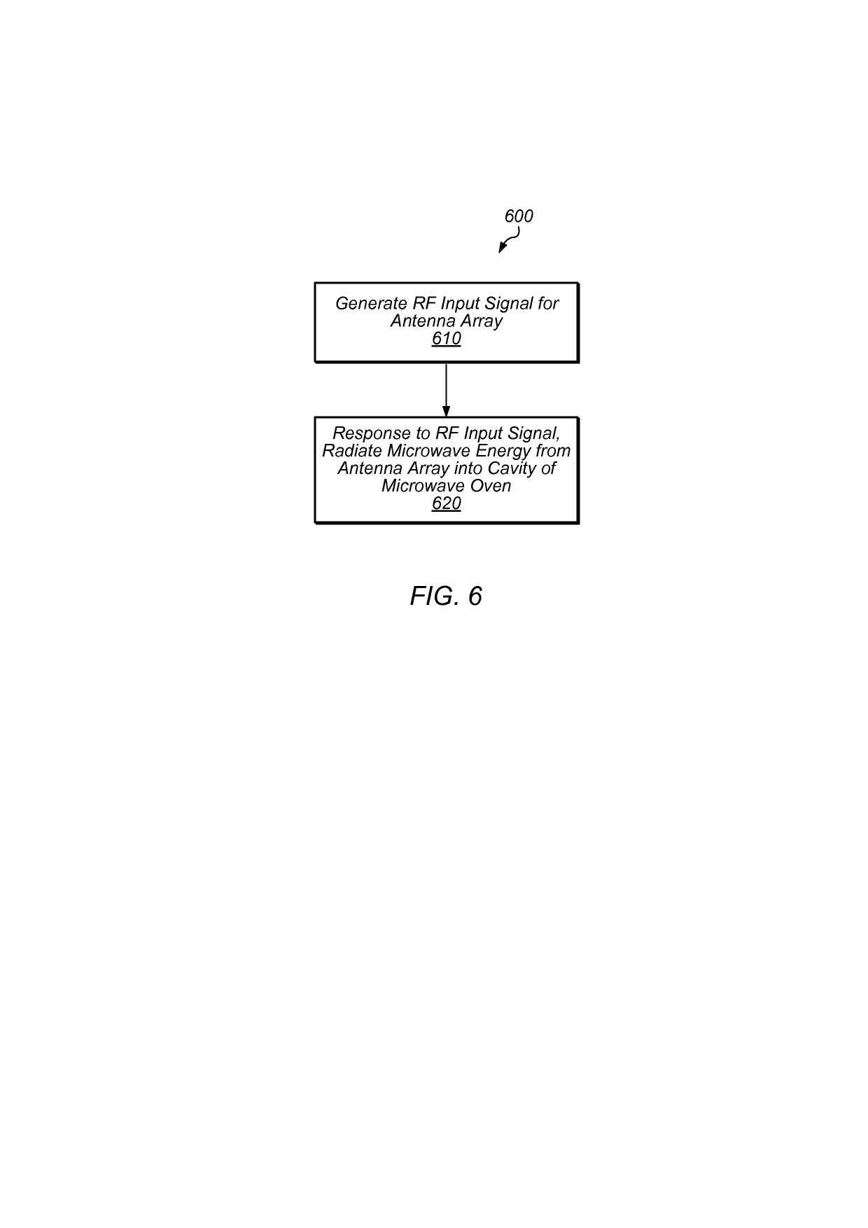

Turning now to FIG. 6, a flow diagram of a method 600 is depicted. Method 600 is one embodiment of method that may be performed by microwave oven such as microwave oven 100. In some instances, performance of method 600 may permit an item to be heated more effectively and may reduce power consumption of the microwave oven.

Method 600 begins in step 610 in which a microwave generates an RF input signal (e.g., a signal 212) for an antenna array (e.g., array 112). As discussed above, in various embodiments, step 610 may include amplifying the signal (e.g., by amplifiers 220) and phase shifting the signal (e.g., by phase shifters 230). In some embodiments, step 610 may include generating multiple RF signals, each having a different respective frequency range. In step 620, the microwave oven radiates microwave energy from the antenna array into a cavity (e.g., cavity 114) of the microwave responsive to the RF signal, such as described above.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a microwave heating unit configured to radiate microwaves into a cavity, wherein the microwave heating unit includes an antenna array coupled to one or more amplifiers, and wherein the antenna array is configured to generate the radiated microwaves.

2. The apparatus of claim 1, wherein the antenna array includes a plurality of antennas, each coupled to a respective on of the one or more amplifiers, and wherein the amplifiers include switching power amplifiers.

3. The apparatus of claim 1, wherein the microwave heating unit defines a cuboidal cavity, and wherein the microwave heating unit includes a first antenna array positioned along a first surface of the cuboidal cavity and a second antenna array positioned along a second surface of the cuboidal cavity.

4. The apparatus of claim 1, wherein the microwave heating unit defines a cylindrical cavity, and wherein the antenna array is included along a cylindrical surface of the cylindrical cavity.

5. The apparatus of claim 1, wherein the apparatus is configured to cause the antenna array to produce a microwave beam directed into the cavity.

6. The apparatus of claim 5, wherein the apparatus is configured to steer the microwave beam within the cavity.

7. The apparatus of claim 5, further comprising:
one or more thermal sensors configured to determine thermal information for an item within the cavity, and wherein the apparatus is configured to adjust a direction of the microwave beam based on the thermal information.

8. The apparatus of claim 7, wherein the one or more thermal sensors include a thermal imaging sensor configured to determine a plurality of temperatures of the item.

9. The apparatus of claim 1, wherein the apparatus is configured to cause the antenna array to produce a first set of microwaves having a first frequency range and a second set of microwaves having a second frequency range.

10. The apparatus of claim 9, wherein the apparatus is configured to adjust the first and second frequency ranges to control depths at which microwaves of the first and second sets penetrate an item in the cavity.

11. A method, comprising:
a microwave oven generating an RF input signal for an antenna array; and
responsive to the RF input signal, the antenna array radiating microwave energy into a cavity of the microwave oven.

12. The method of claim 11, further comprises:
the microwave oven passing the RF input signal through a plurality of amplifiers, each coupled to a respective antenna in the antenna array.

13. The method of claim 12, wherein the plurality of amplifiers are solid-state switching amplifiers.

14. The method of claim 11, wherein the antenna array is one of a plurality of antenna arrays within the microwave oven, and wherein the method further comprising radiating microwave energy from the plurality of antenna arrays into the cavity.

15. The method of claim 11, further comprises:
the microwave oven causing the antenna array to produce a microwave beam, by adjusting a phase and an amplitude of the RF input signal for each antenna in the antenna array.

16. The method of claim 15, further comprising:
the microwave oven measuring temperatures of an item within the cavity; and
the microwave oven steering the microwave beam based on the measured temperatures.

17. The method of claim 16, wherein the microwave oven measures the temperatures with a thermal imaging sensor.

18. The method of claim 16, further comprising:
the microwave oven steering a plurality of microwave beams to different locations on an item based on the measured temperatures.

19. The method of claim 11, further comprising:
the microwave oven generating a plurality of RF input signals, each having a different respective frequency; and
responsive to the plurality of RF input signals, the antenna array radiating different frequency ranges of microwaves.

20. The method of claim 19, further comprising:
the microwave oven adjusting a depth at which a frequency range penetrates an item by adjusting a frequency of one of the plurality of RF input signals corresponding to the frequency range.
